(19) United States
(12) Patent Application Publication
(10) Pub. No.: US 2026/0080218 A1
(43) Pub. Date: Mar. 19, 2026

(54) NEURAL NETWORK ARCHITECTURE FOR PROCESSING OF MULTIDIMENSIONAL POLYLINES AND POLYGONS

(71) Applicant: Qualcomm Incorporated, San Diego, CA (US)

(72) Inventors: Mohammadreza MALEK-MOHAMMADI, Solna (SE); Farhad GHAZVINIAN ZANJANI, Almere (NL); Behnaz REZAEI, San Diego, CA (US); Saeed DABBAGHCHIAN, Bromma (SE); Senthil Kumar YOGAMANI, San Diego, CA (US)

(21) Appl. No.: 18/889,283

(22) Filed: Sep. 18, 2024

(51) Int. Cl. G06N 3/0464; B60W 50/00

(52) U.S. Cl. CPC G06N 3/0464; B60W 50/0097

(57) ABSTRACT

Certain aspects of the present disclosure provide techniques for representing polylines and polygons. A method generally includes obtaining a ordered set of points that represent a polyline or a polygon in a multidimensional space; forming two or more channels from the ordered set of points, each channel has a respective set of coordinate values that corresponds to a respective coordinate direction in the multidimensional space; inputting the two or more channels into a one-dimensional convolutional neural network (1D CNN); and obtaining, as output from the 1D CNN, a feature vector representation of the polyline or polygon.

### INTRODUCTION

### Field of the Disclosure

Aspects of the present disclosure relate to techniques for processing multidimensional polylines and polygons.

### DESCRIPTION OF RELATED ART

Neural networks are a subset of machine learning and are at the heart of deep learning algorithms. Neural networks are comprised of node layers, containing an input layer, one or more hidden layers, and an output layer. Each node connects to other nodes in an adjacent layer and has an associated weight and threshold. If the output of any individual node is above a specified threshold value, the node may be activated, sending data to connected nodes in the next layer of the network. Otherwise, no data may be passed along to the next layer of the network. There are various types of neural networks, which are used for different use cases and data types. For example, recurrent neural networks are commonly used for natural language processing and speech recognition. By contrast, convolutional neural networks (CNNs) are more often utilized for classification and computer vision tasks. In particular, CNNs provide a scalable approach to image classification and object recognition tasks, leveraging principles from linear algebra, specifically matrix multiplication, to identify patterns within an image. For example, object recognition is a key technology behind driverless automobiles, enabling autonomous automobiles to adjust to traffic conditions, avoid pedestrians and physical hazards, and adjust the automobile's trajectory and speed without a human being at the controls.

### SUMMARY

One aspect provides a method for representing polylines and polygons. The method comprises obtaining an ordered set of points that represent a polyline or a polygon in a multidimensional space. The method comprises forming two or more channels from the ordered set of points. Each channel has a respective set of coordinate values that corresponds to a respective coordinate direction in the multidimensional space. The method comprises inputting the two or more channels into a one-dimensional convolutional neural network (1D CNN), and obtaining, as output from the 1D CNN, a feature vector representation of the polyline or polygon.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1A depicts an example curve and corresponding polyline.

FIG. 1B depicts an example closed curve and corresponding polygon.

FIG. 2 depicts an example polyline in a two-dimensional (2D) space.

FIG. 3 depicts an example ordered set of points that can represent a polyline or a polygon in an n-dimensional (n-D) space.

FIG. 4 depicts example channels of a channel matrix.

FIG. 5 depicts an example network architecture of a 1D convolutional neural network (CNN).

FIGS. 6A-6C depict an example of convolution executed in a first convolution layer and a second convolution layer of the 1D CNN depicted in FIG. 5.

FIG. 7A depicts an example autoencoder formed from convolution layers of a 1D CNN.

FIG. 7B depicts an example process for compressing data corresponding to a polyline or a polygon.

FIG. 8 depicts an example map with objects represented by polylines and polygons.

FIG. 9 depicts a flow diagram of an example method for determining objects in a map.

FIG. 10 depicts an example of clusters of feature vectors that correspond to different types of objects.

FIG. 11 depicts an example of an aerial map of a region of land and polygons corresponding to objects located in the aerial map.

FIGS. 12A-12C depict example aspects of obtaining a predicted future trajectory for an automobile.

FIG. 13A depicts examples of handwritten numbers.

FIG. 13B depicts an example of generating a feature vector that represents a handwritten number.

FIG. 14 depicts an example method for representing a polyline or a polygon.

FIG. 15 depicts aspects of an example processing system.

### DETAILED DESCRIPTION

In many data structures, such as digital images, the outline of an object can be represented as a polyline or a polygon. A polyline is composed of an ordered set of points, in which line segments connect consecutive points. A polyline can be used to approximate a curve in a multi-dimensional space. A polygon is a closed polyline where the beginning and ending points of the polyline are the same. Accordingly, a polygon may be a type of polyline. For example, a polyline may be an open polyline or a closed polyline (e.g., a polygon). For example, polylines and/or polygons may be used in digital maps, such as high-definition (HD) digital maps, to represent boundaries of objects, such as roads, rivers, lines, bodies of water, and buildings. In certain aspects, an automobile trajectory may be represented by a polyline in which the curve and shape of the trajectory are represented by dividing the trajectory into line segments.

Feature extraction is a process in which machine learning is used to extract feature(s) from input data. In certain aspects, such as where the input data represents one or more objects, object identification may be performed based on the extracted feature(s), such as using machine learning, to identify a type of the one or more objects represented in the input data. In certain aspects, where the input data includes polyline(s) or polygon(s), such as an ordered set of points of a polyline or polygon, the extracted feature(s) may be used to identify one or more objects represented by the polyline(s) or polygon(s). For example, feature extraction and object identification may be used to determine a type of object a polyline represents, such as a curb of a road, path of a vehicle, a river bank, or the like or a type of object a polygon represents, such as a pedestrian crossing, a building, a body of water, or the like, such as in a map (e.g., a high definition (HD) map). In certain aspects, feature extraction separates relevant features from irrelevant ones. For example, a machine learning algorithm may receive as input the ordered set of points of a polyline or a polygon and output one or more extracted features. The one or more extracted features can be used for various tasks, such as object type identification of an object represented by the polyline or a polygon, future trajectory prediction for a current trajectory represented by the polyline or polygon, or the like.

Some machine learning techniques may have certain shortcomings when used for extracting features from polylines and/or polygons. For example, a multi-layer perceptron (MLP) may be used to extract features from polylines and/or polygons. An MLP may be an artificial neural network including fully connected nodes, and a nonlinear activation function, such as organized in a least three node layers. MLPs may be trained by changing connection weights between nodes after each piece of data is processed, based on the amount of error in the output compared to the expected result. For an MLP to be used for feature extraction of a polyline or a polygon, the full set of points comprising the polyline or the polygon are input to the input layer of the MLP. However, typical MLPs do not efficiently utilize the geometrical and spatial properties of polylines or polygons to extract features. As a result, an extracted feature output from a typical MLP corresponding to an ordered set of points of a polyline or a polygon can be inaccurate. Moreover, typical MLPs are not sample efficient. Sampling efficiency is the amount of labeled data required to train an MLP. For example, a typical MLP may require millions of training examples to become proficient at the task of feature extraction from sets of points comprising polylines and polygons.

Other machine learning techniques that may be used to extract features from polylines and/or polygons include two-dimensional (2D) and three-dimensional (3D) convolutional neural networks (CNNs). CNNs may be distinguished from some other neural networks by providing superior performance with image data, or other similar data. Some CNNs may be designed to work with 2D and/or 3D grid-structured data as input, and may have strong spatial dependencies in local regions of the grid. An example of grid-structured data is a two-dimensional image, or a 2D (or n-D) representation of a scene, such as representing objects and/or trajectories of objects.

CNNs may be configured with three types of layers: one or more convolutional layers (e.g., a plurality of convolutional layers), pooling operation layer, and a final fully-connected layer. The one or more convolutional layers may be the first layers of a CNN. The convolution process may include the application of specialized filters called “kernels” that are used to traverse data, such as an image, to learn complex (e.g., visual) patterns. The kernels may be moved across an image or representation of a scene, performing element-wise multiplication with the part of the image covered by the kernel.

Typical 2D and 3D CNNs applied to data have very large computational requirements and occupy a large amount of memory, which may be impractical for feature extraction of polylines and polygons. For example, to effectively use a 2D CNN to extract features of 2D polylines or 2D polygons, the polylines or polygons may first need to be represented in a sparse 2D image. In other words, the 2D polylines or 2D polygons may need to be embedded in a 2D image and surrounded by pixels of nearly the same pixel value. As a result, sliding a 2D kernel over the full 2D image to extract features of polylines or polygons results in extra unnecessary convolutional operations applied to pixel data that does not contain data associated with the polylines or polygons. Likewise, to effectively use a 3D CNN to extract features of 3D polylines or 3D polygons, the polylines or polygons may need to be represented in a sparse 3D image volume. As a result, sliding a 3D kernel over the 3D image results in extra unnecessary convolutional operations.

Certain aspects of methods, systems and apparatuses associated with new network architecture described herein may provide a technical solution to the above described technological problems with existing MLPs and 2D and 3D CNNs and may improve the state of the art. In certain aspects, such a network architecture efficiently represents multidimensional polylines and polygons. In certain aspects, the network architecture exploits inductive bias or geometrical properties that are present in polylines and polygons. In certain aspects, an ordered set of points representing a polyline or polygon are stacked in a matrix to be processed by the network architecture. In certain aspects, the network architecture includes a one-dimensional (1D) CNN, such as including one or more (e.g., a plurality) of 1D convolutional layers. In certain aspects, the network architecture supports n dimensional coordinates of a polyline or a polygon that are fed as input channels (e.g., each channel representing one of the n dimensions). The channels may be processed within the 1D CNN. In certain aspects, kernels of the 1D CNN are configured (e.g., trained) to combine the features extracted from channels of the polyline or polygon. As a result, in certain aspects, the network architecture learns how to treat and combine coordinates to efficiently extract features from the input channels. In some aspects, the 1D convolutional layers of the 1D CNN can be used as an encoder and 1D transposed convolution layers can used as decoders.

In certain aspects, the network architecture provides a more efficient way of using the geometrical, local, and/or global properties of polylines and/or polygons. For example, the network architecture may significantly reduce the number of training samples, the complexity and number of learnable parameters, and/or the risk of overfitting. In some cases, though the network architecture has lower complexity, the network architecture may extract more useful and compact features from polylines and polygons than MLPs and 2D and 3D CNNs. In certain aspects, by using spatial information embedded in the ordered sets of points associated with polylines and/or polygons, the network architecture may decrease the number of trainable parameters of the 1D CNN and hence reduce the amount of training data needed for training the 1D CNN. The sample efficiency may also translate to reduced cost of annotation of training data as a smaller number of samples of the training data may be annotated. The network architecture may also use far fewer computational resources and less memory than an MLP and 2D and 3D CNNs. This in turn may imply lower computational budget than an MLP and 2D and 3D CNNs.

In certain aspects, the network architecture may be used in a number of practical applications, including, but not limited to, one or more of prediction in online map generation by feature extraction from polylines and polygons, predicting the trajectory of an object (e.g., automobile), compressing of polyline and polygon data, classification of objects (e.g., in aerial or satellite maps), and (e.g., handwritten) shape recognition.

### Aspects Related to Using a Network Architecture to Represent Multidimensional Polylines and Polygons

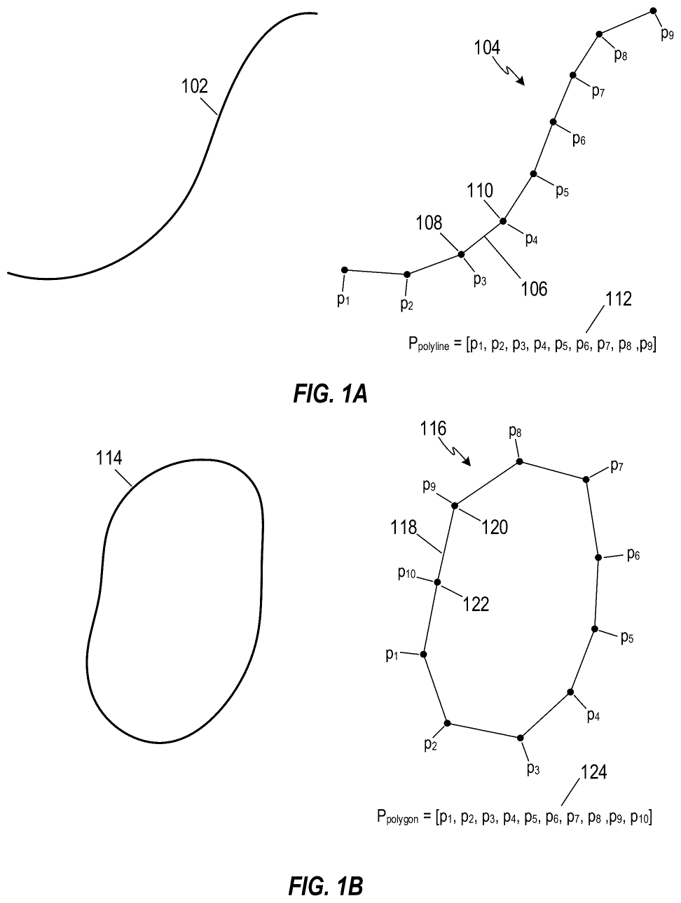

FIG. 1A depicts an example of a curve 102 in an n-dimensional (n-D) space, where n is a positive integer greater than or equal to two. FIG. 1A also depicts an example of a polyline 104 representation of the curve 102. In this example, the polyline 104 is composed of an ordered set of points pᵢ, where i=1, 2, . . . , 9. Line segments connect pairs of points that correspond to points along the curve 102. For example, a line segment 106 connects a pair of points 108 and 110 denoted by p₃ and p₄, respectively. The polyline 104 is represented by an ordered set of points 112 denoted by P_{polyline}.

FIG. 1B depicts an example of a closed curve 114 in the n-D space and an example of a polygon 116 representation of the closed curve 114. In this example, the polygon 116 is composed of ten points that are connected by ten line segments. Each line segment connects a pair of points that corresponds to points along the closed curve 114. For example, a line segment 118 connects a pair of points 120 and 122 denoted by p₉ and p₁₀, respectively. The polygon 116 is represented by an ordered set of points 124 denoted by P_{polygon}.

Each point of the polyline 104 and the polygon 116 is composed of a set of coordinates in the n-D space and is denoted by pᵢ=(x_{1,i}, . . . , x_{n,i}), where subscript i is a point index and a second subscript corresponds to one of n different coordinate directions in the n-D space. For example, x_{1,i} corresponds to a first coordinate direction in the n-D space.

The coordinates of the points comprising a polyline or a polygon are arranged to form a channel matrix representation of the ordered set of points. The ordered set of points are arranged sequentially in the channel matrix so that adjacent columns correspond to adjacent points in the polyline or polygon and each row of coordinate values called a “channel” corresponds to a respective coordinate direction in the n-D space.

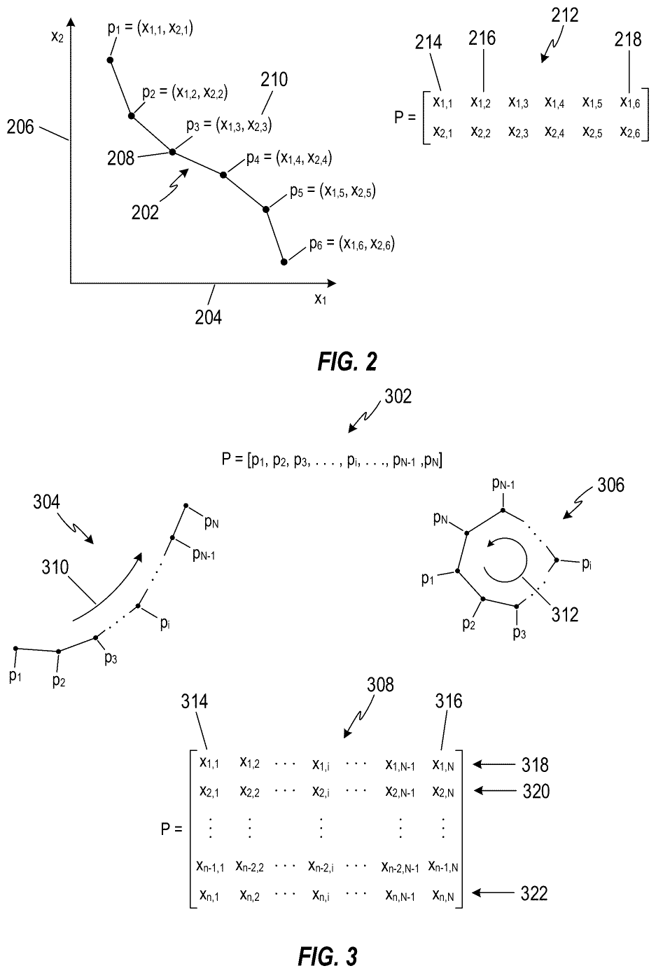

FIG. 2 depicts an example of a polyline 202 in a two-dimensional (2D) space. A horizontal arrow represents a first coordinate axis 204 of the 2D space. A vertical arrow represents a second coordinate axis 206 of the 2D space. Each point of the polyline 202 contains two coordinate values. For example, a point 208 denoted by p₃ is composed of coordinate values 210.

FIG. 2 also depicts an example of a channel matrix 212 representation of the ordered set of points of the polyline 202. In this example, the first row of the channel matrix 212 is composed of coordinate values that correspond to the first coordinate axis 204 and the second row of the channel matrix 212 is composed of coordinate values that correspond to the second coordinate axis 206. The columns of the channel matrix 212 can be arranged to correspond to the order of the points along the polyline 202. In other words, the points are arranged so that each pair of adjacent columns are composed of corresponding pairs of endpoints of a line segment of the polyline. For example, a first column 214 contains the coordinates of the first point p₁, a second column 216 contains the coordinates of the second point p₂, and a last column 218 contains the coordinates of the last point p₆.

FIG. 3 depicts an example set of points 302 that can represent a polyline 304 or a polygon 306 composed of N points in the n-D space. The set of points 302 correspond to columns in a channel matrix 308. The columns of the channel matrix 308 are arranged to correspond to the order of the points along the polyline 304 indicated by directional arrow 310 or along the polygon 306 indicated by directional arrow 312. For example, the first column 314 contains the coordinates of the point p₁ of the polyline 304 or the polygon 306 and the last column 316 contains the coordinates of the point py of the polyline 304 or the polygon 306.

The channel matrix 308 is composed of n rows that corresponds to the n dimensions of the n-D space. For example, row 318 contains the coordinate values of a first coordinate axis in the n-D space. Row 320 contains the coordinate values of a second coordinate axis in the n-D space. Row 322 contains the coordinate values of the n-th coordinate axis in the n-D space.

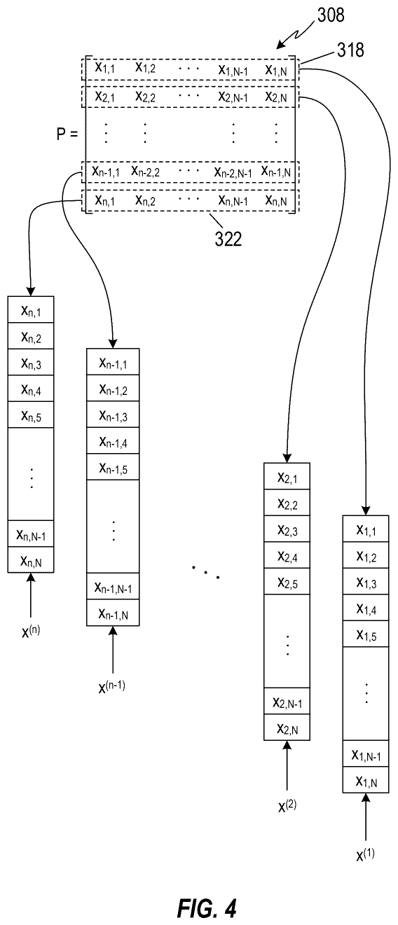

FIG. 4 depicts channels of the channel matrix 308 in FIG. 3. For example, the coordinate values of the row 318 form a channel denoted by x⁽¹⁾. The coordinate values in the n-th row form a channel denoted by x⁽ⁿ⁾.

The n channels may be input to a 1D convolutional neural network (CNN) to obtain a feature vector that represents the corresponding polyline or polygon. In certain aspects, the 1D CNN comprises at least one convolutional layer, a rectified linear unit (ReLU) layer, an optional pooling layer, and an optional fully connected layer. In other aspects, the 1D CNN may include batch normalization or another type of normalization.

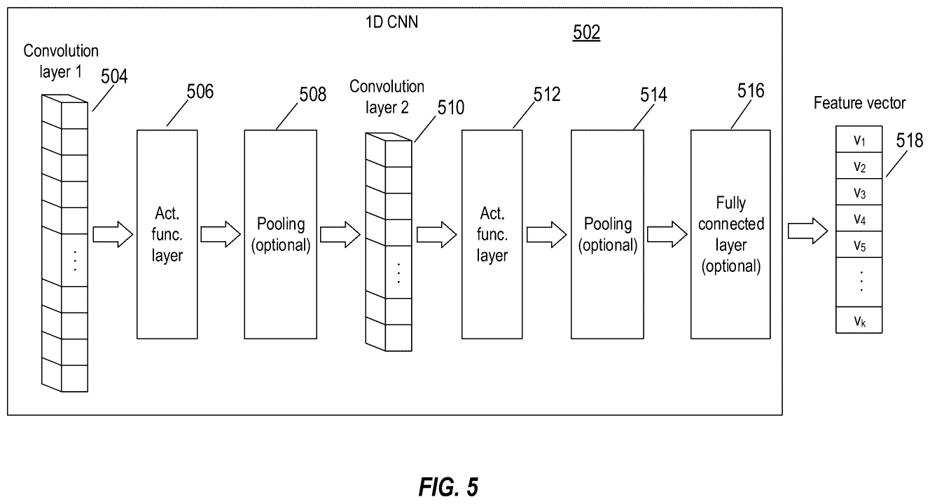

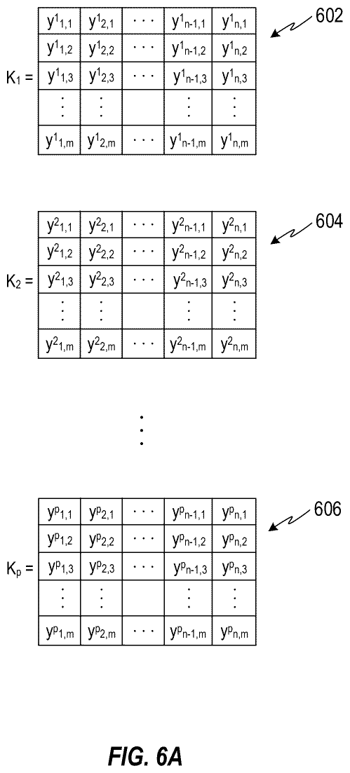

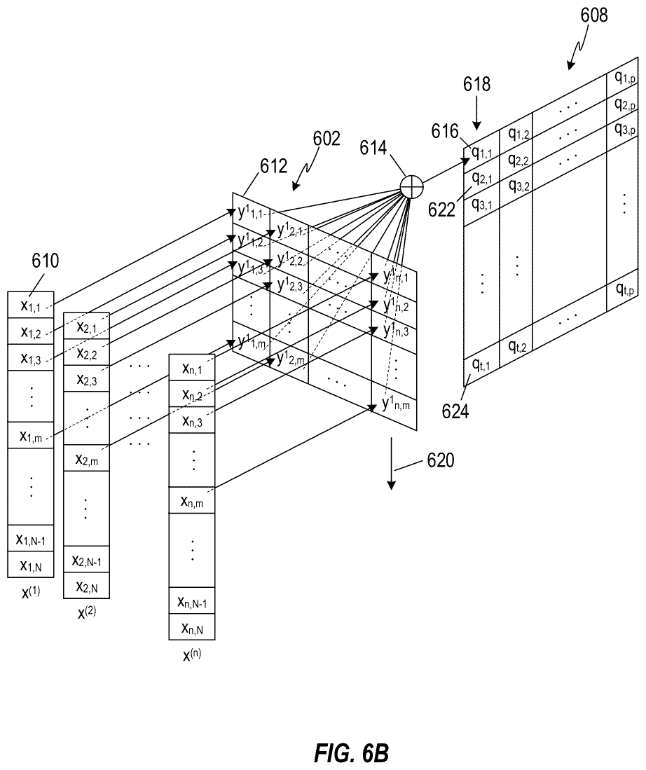

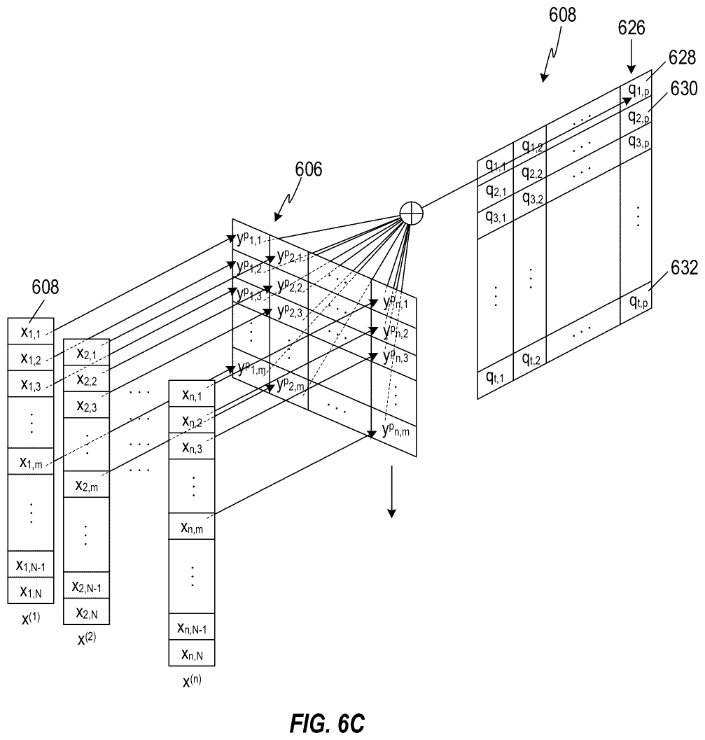

FIG. 5 depicts an example network architecture of a 1D CNN 502. In this example, the 1D CNN 502 includes a first convolutional layer 504, an activation function layer 506, an optional pooling layer 508, a second convolution layer 510, an activation layer 512, an optional pooling layer 514, and may have a fully connected layer 516. Additional layers that may be included in the 1D CNN 502 include a flatten layer. The first convolutional layer 504 and the second convolution layer 510 perform feature extraction from the n channels. The first convolutional layer 504 comprises a first set of one or more kernels convolved with the channels as described below with reference to FIGS. 6A-6C. The second convolution layer 510 comprises a second set of one or more kernels convolved with the elements of the output from the first convolutional layer 504.

In practice, the number of convolutional layers of the 1D CNN 502 can vary from as few as a single convolution layer (e.g., corresponding to a first set of one or more kernels) to multiple convolutional layers. The activation function layers 506 and 512 apply an activation function to the first and second convolution layers 504 and 510, respectively, in the 1D CNN 502.

In one aspect, the activation function used in one or both of the activation function layers 506 and 512 may be an ReLU activation function represented by ƒ(x)=max(0,x), where x is a real number input the activation layers. If the input value x is greater than zero, the output of the ReLU activation function is equal to the input value x. On the other hand, if the input value x is negative or zero, the output of the ReLU activation function is zero.

In other aspects, one or both of the activation function layers 506 and 512 may be performed with a leaky ReLU activation function. For example, the leaky ReLU function can be represented by ƒ(x)=x, if x>0, and ƒ(x)=ax, if x≤0, where 0<a<1.

In still other aspects, one or both of the activation function layers 506 and 512 may be performed with an exponential linear unit (ELU). For example, the ELU is represented by ƒ(x)=x, if x>0, and ƒ(x)=α(exp (x)−1), where a>0, if x≤0.

The pooling layers 508 and 514 are optional but may be used to perform dimensionality reduction with an unweighted kernel. For example, the pooling layers 508 and 514 can perform dimensionality max pooling or average pooling with elements of the channel covered by the unweighted kernel. Max pooling is a pooling operation that is applied to elements that share the same coordinate. Max pooling selects a maximum element from elements of input to the pooling layer covered by the unweighted kernel. Thus, the output after the optional max-pooling layer contains the largest elements of the channels. Average pooling computes the average of the elements present in the elements of the channels covered by the unweighted kernel. Thus, while max pooling gives the largest element in a particular patch of elements covered by the channels, average pooling gives the average value of elements of the channel covered by the unweighted kernel. The fully connected layer 516 is optional but can be used to connect elements of the values output from the ReLU layer 512, or the optional pooling layer 514, to a feature vector 518, which is the output of the 1D CNN 502.

In certain aspects, the n channels are convolved separately with p kernels denoted by K₁, . . . , Kₚ. Each of the kernels is an m by n matrix of weights. FIG. 6A depicts an example notation of the p kernels used in the first convolution layer 504 of FIG. 5. In this example, the first kernel K₁ 602 is an m by n matrix of weights denoted by

$${y}_{i , j}^{1} ,$$

the second kernel K₂ 604 is an m by n matrix of weights denoted by

$${y}_{i , j}^{2} ,$$

and p-th kernel Kₚ 606 is an m by n matrix of weights denoted by

$${y}_{i , j}^{p} ,$$

were i=1, . . . , n and j=1, . . . , m.

Convolution in the first convolution layer 504 is performed by incrementally stepping each of the kernels along the n channels. At each step, element-wise multiplication with the coordinate values of the n channels that match up with the weights of a kernel is performed followed by summing the multiplication results. The kernel is then moved to a next location in the n channels and the element-wise multiplication process is repeated. This operation of multiplying, summing, and moving the kernel to a next location is repeated for each of the p kernels. The stride is the number of places by which the kernel moves for each convolution step. A stride of one means the kernel is moved one place at a time and the product is calculated for the values of the channels that match up with the weights of the kernel. The output of convolving the n channels by p kernels with dimensions m×n in the first convolution layer 504 is a t×p output matrix with output values denoted by q_{i,j}, where i=1, . . . , t, j=1, . . . , p, and t=N−m+1 with the stride equal to one. Note that when the input is not padded, t=(N−m)/s+1, where the stride is denoted by s and s>1.

FIG. 6B depicts an example of convolving the first kernel K₁ 602 with the n channels to obtain output values in a first column of an output matrix 608 of the 1D CNN 502. At a first step location, element-wise multiplication with the coordinate values of the n channels that match up with the weights of the kernel K₁ 602 is performed. Directional arrows represent element-wise multiplication of the first m coordinate values in each of the n channels that are aligned with and multiplied by the m weights in each of the n columns of the kernel K₁ 602. For example, a coordinate value 610 is aligned with and multiplied by a weight 612. A summing junction 614 represents summing the products obtained from multiplying each of weights in the kernel K₁ 602 with corresponding coordinate values in each of the n channels to obtain an output value q_{1,1} 616 in a first column 618 of the output matrix 608. The kernel K₁ 602 is stepped as indicated by directional arrow 620 with a stride of one. Element-wise multiplication is performed with the next m coordinate values in each of the n channels and the m weights in each of the n columns of the kernel K₁ 602 followed by summing the products to obtain an output value q_{2,1}622. The output value q_{t,1}624 is obtained when the kernel K₁ 602 is aligned with the last m coordinate values in the n channels.

FIG. 6C depicts an example of convolving the p-th kernel Ky 606 with the n channels to obtain output values in a p-th column (e.g., last column) 626 of the output matrix 608. At a first step location, element-wise multiplication with the coordinate values of the n channels that match up with the weights of the kernel Ky 606 is performed. In this example, an output value q_{1,p} 628 in the p-th column 626 is obtained when the kernel Kₚ 606 is aligned with the first m coordinate values in the n channels. An output value q_{2,p} 630 is obtained when the kernel Kₚ 606 is stepped down and aligned with the second m coordinate values in the n channels. An output value q_{t,p} 632 is obtained when the kernel Ky 606 is aligned with the last m coordinate values in the n channels.

The activation function in the activation function layer 506 is applied to each of the elements of the output matrix obtained in the first convolution layer 504. For example, for the first element q_{1,1} 610, the ReLU activation function gives ƒ(p_{1,1})=max(0, q_{1,1})=q_{1,1}, if q_{1,1}≥0. Otherwise, the ReLU activation function ƒ(q_{1,1})=0, if q_{1,1}<0.

Convolution can be performed in the second convolution layer 510 with a different set of one or more kernels applied to the output matrix obtained in the first convolution layer 504.

The number of convolution layers in the network architecture of FIG. 5 is not limited to two. In some aspects, the number of convolution layers can be as few as one or may have three, four, five or more convolution layers.

In some aspects, the 1D CNN can be a dilated 1D CNN, in which dilated convolution is performed. Dilated convolution is a technique that dilates the kernel by inserting holes or gaps between consecutive weights. In other words, dilated convolution is performed as described above with reference to FIGS. 6B-6C, but convolution is performed with expanded p kernels that contain gaps to cover a larger area of the n channels. Dilated convolution enables the 1D CNN to have a larger receptive field without increasing the number of parameters. The dilation rate determines the size of the gaps. When the dilation rate is 1, the dilated convolution reduces to a convolution process described above with reference to FIG. 6B-6C. The dilation rate effectively increases the receptive field of the kernel without increasing the number of parameters, because the kernel is still the same size, but with gaps between the weights.

In some aspects, the 1D CNN can be a deformable 1D CNN. The convolution process described above with reference to FIGS. 6A-6C extracts and captures features of the n channels. By contrast, with deformable 1D CNN, the weights of the kernel are augmented with an offset. As a result, the grid associated with each of the p kernels becomes irregular and the locations of the weights in the kernels are no longer arranged in a regular order. The weights of the kernels are not necessarily aligned with the coordinate values of the n channels as shown in FIGS. 6B-6C. In deformable 1D CNN the weights of the kernels can be aligned with coordinate values that are not in a regular grid of coordinate values.

The 1D CNN network architecture according to aspects described herein, such as the examples depicted in FIGS. 5-6C, may provide a number of advantages over existing networks, such a MLP and 2D and 3D CNN. For example, the 1D CNN network architecture may extract local and global properties of the curve and shape approximated by the polyline or polygon. The convolutional layers of the 1D CNN may extract features related to the curvature of the polyline or polygon and as the process proceeds deeper into the network of the 1D CNN more high-level features may be extracted than would otherwise be obtained with existing networks. The feature vector output from the 1D CNN 502 may be used for a number of tasks, such as related to the object represented by the polyline or the polygon, such as identifying a type of the object, predicting a trajectory of the object, etc.

### Applications of the 1D CNN

In some aspects, the convolution process of the 1D CNN 502 can be used to encode polyline(s) and/or polygon(s) into a different lower dimensional domain. In other words, in certain aspects, the convolution layer(s) of the 1D CNN 502 are an encoder that performs data compression by encoding the ordered sets of data associated with polyline(s) and/or polygon(s) into a lower dimensional space. As a result, the compressed polyline(s) and/or polygon(s) can be stored in a data storage device, or transmitted over a network, with fewer bits than would otherwise be used to store or transmit the original sets of data associated with the polyline(s) and/or polygon(s). The compressed polyline(s) and/or polygon(s) may be decompressed using a decoder that executes transposed convolution and up-sampling. The decoder may be lossy. As a result, the output of the decoder is recovered channels of the polyline(s) and/or polygon(s), which approximates the original channels of the polyline or polygon that was input to the encoder.

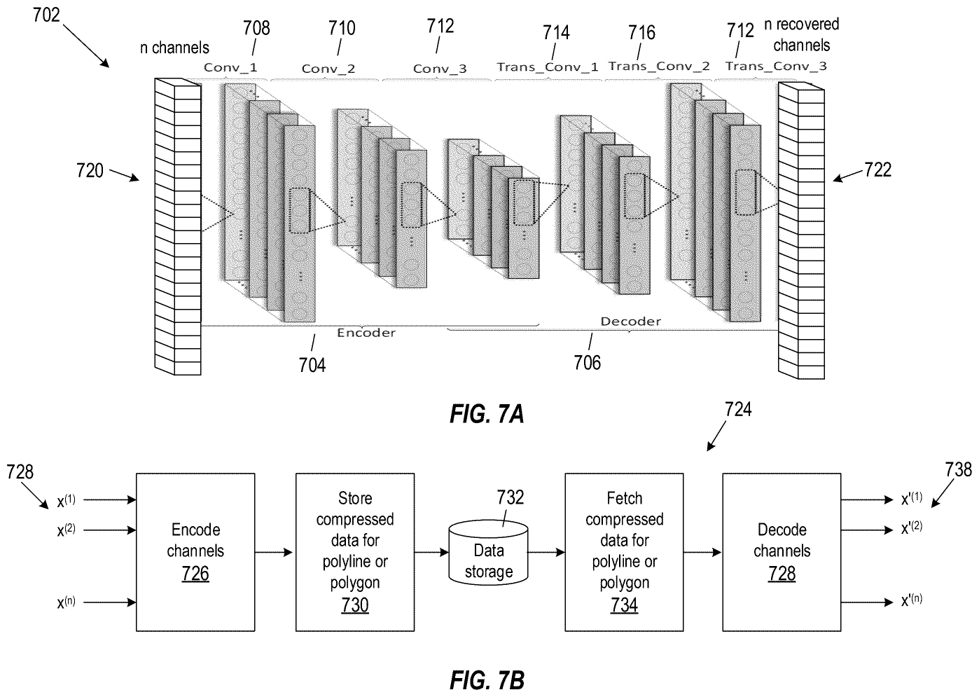

FIG. 7A depicts an example autoencoder formed from the convolution layer(s) of an example 1D CNN. In this example, the autoencoder 702 comprises an encoder 704 and a decoder 706. The encoder 704 is formed from three convolution layers 708, 710, and 712, though as discussed, a different number of convolution layers may be included. The decoder 706 is formed from three transposed convolution layers 714, 716, and 718 (though a different number of transposed convolution layers may be included) that correspond to the convolution layers 708, 710, and 712. In the example of FIG. 7A, the convolution layers 708, 710, and 712 encode or compress the n channels 720 into a lower dimensional space. The transposed convolution layers 714, 716, and 718 produce n recovered channels of a reconstructed polyline or polygon 722 that approximate the original n channels 720.

FIG. 7B depicts an example process 724 for reducing the amount of data used to store data associated with a polyline or a polygon. In block 726, channels 728 of a polyline or a polygon are compressed using an encoder such as the encoder 704 of FIG. 7A. In block 730 the compressed data is stored in a data storage device 732. The compressed data stored in the data storage device 732 is composed of fewer bits of information than the channels 728. In block 734, the compressed data is fetched from the data storage device 732. In block 736, a decoder, such as the decoder 706 in FIG. 7A, executes transposed convolution to obtain n recovered channels of the polyline or polygon which approximates the channels 728 of the polyline or polygon.

In certain aspects, the operations represented by blocks 726, 728, 730, and 734 may be performed on the same computing device. In certain aspects, the operations represented by blocks 726, 728, 730, and 734 may be performed on different computing devices. For example, the encode channels process represented by block 726 and the store compressed data process represented by block 730 may be performed on a first computing device. The fetch compressed data process represented by block 734 and the decode channels process represented by block 728 may be performed on a second computing device. The first and second computing devices may be located in different physical locations and access the data storage 732 over a network.

In certain aspects, map generation methods (e.g., HD map generation methods) generate polylines and/or polygons as representations of objects, such as road and lane boundaries, roundabouts, pedestrian crossings, or the like from sensor data obtained from cameras, lidar sensors, and other sensors. The objects may be continuous and extend to multiple frames. Bounding boxes may be used in computer vision technologies to identify and categorize items in images and videos. However, the objects of the map may not be captured by bounding boxes in a single frame. In other words, the objects of the map are extended over multiple frames and bounding boxes are not able to capture the objects. To detect these type of objects, detections may be made in previous time instants or frames. The 1D CNN described above may be a (e.g., efficient) way to transform the objects into a low-dimensional space where predictions from the same objects lie within the same cluster, while predictions from different objects are farther away from each other.

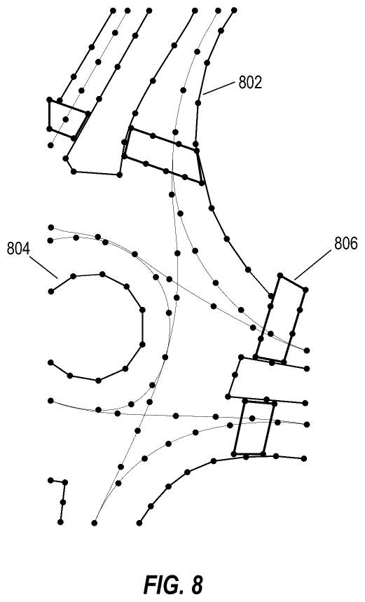

FIG. 8 depicts an example map with objects represented by polylines and polygons. For example, polyline 802 represents a road boundary. Polygon 804 represents a roundabout. Polygon 806 represents a pedestrian crossing.

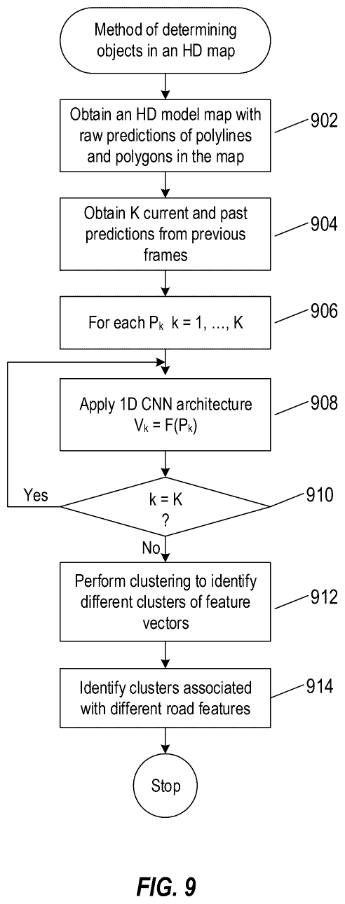

FIG. 9 depicts a flow diagram of a method for determining objects in a map.

In block 902, a model map with (e.g., raw predictions of) polyline(s) and/or polygon(s) in the map is obtained. Raw predictions are obtained from a machine learning model for HD map generation and have not been processed.

In block 904, K current and past predictions of objects in the map are obtained. Let Pₖ= [p_{1,k}, p_{2,k}, . . . , p_{N,k}], where k=1, 2, . . . , K and N is the number of points per polyline or polygon, be the set of points of the k-th predicted polyline or polygon and let K be the total number of predictions.

A loop beginning with block 906 repeats the computational operation represented by block 908 for each of the K predicted polylines or polygons obtained in block 904.

In block 908, the n channels of the k-th predicted polyline or polygon Pₖ is input to a 1D CNN, such as described above with reference to FIGS. 5-6B, to obtain as output a corresponding feature vector Vₖ represented by

$${V}_{k} = F ( {P}_{k} ) \qquad ( 1 )$$

where F (·) is the function implemented by the 1D CNN based on feature extraction.

In block 910, when index k equals K, control flows to block 912. Otherwise, the operation represented by block 908 is repeated for a next of the predicted polyline or polygons.

In block 912, a machine learning (ML) clustering technique is used to identify clusters of feature vectors. Each cluster of feature vectors corresponds to a different object type (e.g., in the map). ML clustering techniques identify groups of similar feature vectors. The ML clustering technique can be K-means clustering, K++ means clustering, hierarchical clustering, or the like.

In block 914, the different clusters of feature vectors obtained in block 912 are identified as corresponding to objects, such as objects in the HD map. The output of clustering may be used to associate similar polylines and polygons with objects in the HD map.

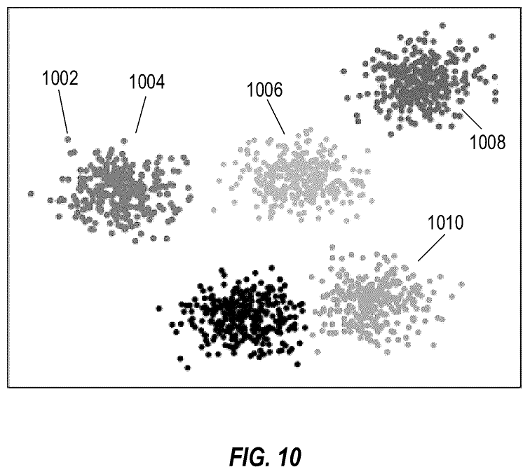

FIG. 10 depicts an example of clusters of feature vectors that correspond to different object types, such as of the map. Each point represents a feature vector output from the 1D CNN in response to receiving as input the n channels corresponding to a predicted polyline or polygon in block 904. For example, a point 1002 represents a feature vector Vₖ which represents the set of points associated with the polyline or polygon Pₖ. FIG. 10 shows five different clusters represented by five different shadings. Each cluster contains feature vectors that correspond to different types of objects and/or different objects of the same type in an HD map. In one aspect, the 1D CNN may be used to generate feature vectors that correspond to polyline representations of objects in an HD map. For example, cluster 1004 can be composed of feature vectors that correspond to polylines that represent road boundaries, and cluster 1006 can be composed of feature vectors that correspond to polylines that represent road center lines.

In one aspect, the 1D CNN may be used to generate feature vectors that correspond to polygon representations of objects in an HD map. For example, the clusters in FIG. 10 may represent features vectors that correspond to polygon representations of objects. For example, cluster 1008 can be composed of feature vectors that correspond to polygon representations of pedestrian crossings, and cluster 1010 can be composed of feature vectors that correspond to polygon representations of roundabouts.

In certain aspects, the 1D CNN can be used to extract features vectors for recognition and classification of objects, such as in an aerial map or satellite image. In certain aspects, HD map methods generate polygons as representations of objects of the aerial map or satellite image, such as roads, buildings, rivers, bodies of water, or the like.

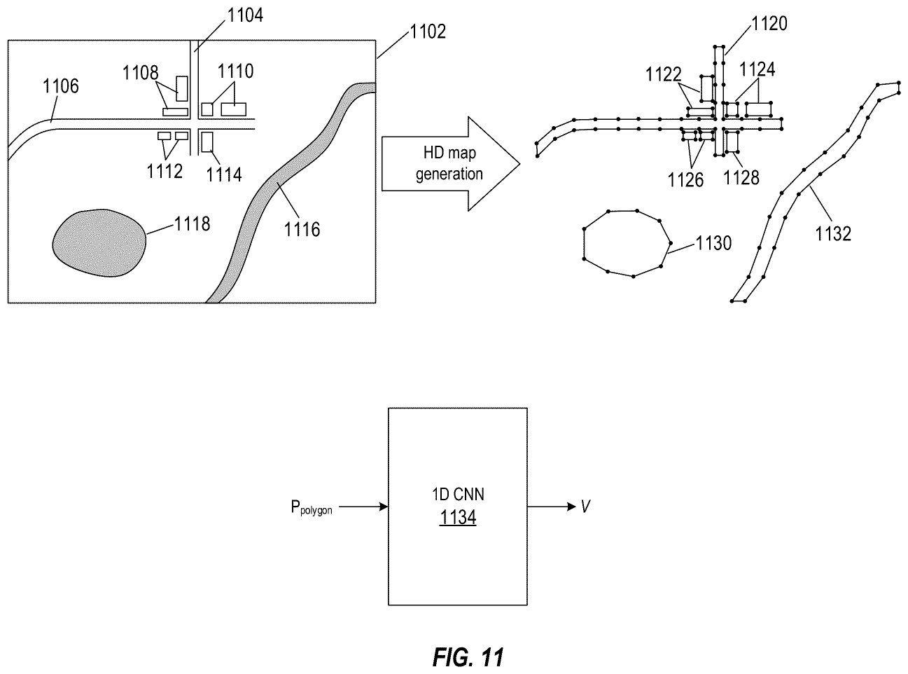

FIG. 11 depicts an example of an aerial map 1102 of a region of land that includes objects 1104, 1106, 1108, 1110, 1112, 1114, 1116, and 1118. Suppose these objects have not been identified. The 1D CNN described above can be used to generate feature vectors for each of the objects and a classification method, such as k-nearest neighbor, can be used to classify the objects for identification based on the feature vectors. In FIG. 11, a map method generates polygon representations of the objects in the aerial map 1102. For example, a polygon 1120 represents the objects 1104 and 1106. Polygons 1122, 1125, 1126, and 1128 represent the objects 1108, 1110, 1112, and 1114. Polygon 1130 represents the object 1116. Polygon 1132 represents the object 1118.

The set of points of each polygon obtained from map generation are input to the 1D CNN represented by block 1134. The 1D CNN generates a feature vector for each of the polygons. The feature vectors can be used to identify the objects using any one of many different types of classification heads appended to the 1D CNN. For example, a softmax classifier is a classification head that may be used to identify the class of the feature vectors output from the 1D CNN. For example, objects 1104 and 1106 can be classified as roads; the objects 1108, 1110, 1112, and 1114 can be classified as buildings, the object 1116 can be classified as a river, and the object 1118 can be classified as a body of water.

In certain aspects, the 2D or 3D coordinate locations of a trajectory of an automobile form a polyline that can be used to predict the trajectory of the automobile using the 1D CNN. The ordered set of points recorded at different points in time form a 3D polyline that approximates the trajectory of the automobile. For example, the ordered set of points of the polyline can be obtained from a global positioning satellite (GPS) locator located in the automobile. Each of the points includes a time stamp. An inverted 1D CNN can be trained to predict the trajectory of an automobile from a polyline approximation of a current trajectory. The inverted 1D CNN may be formed by a transposed 1D CNN.

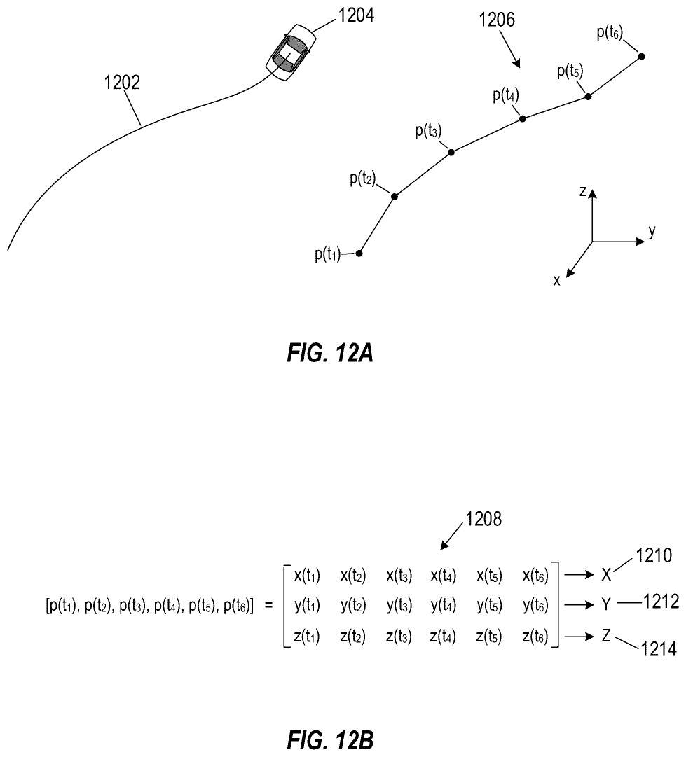

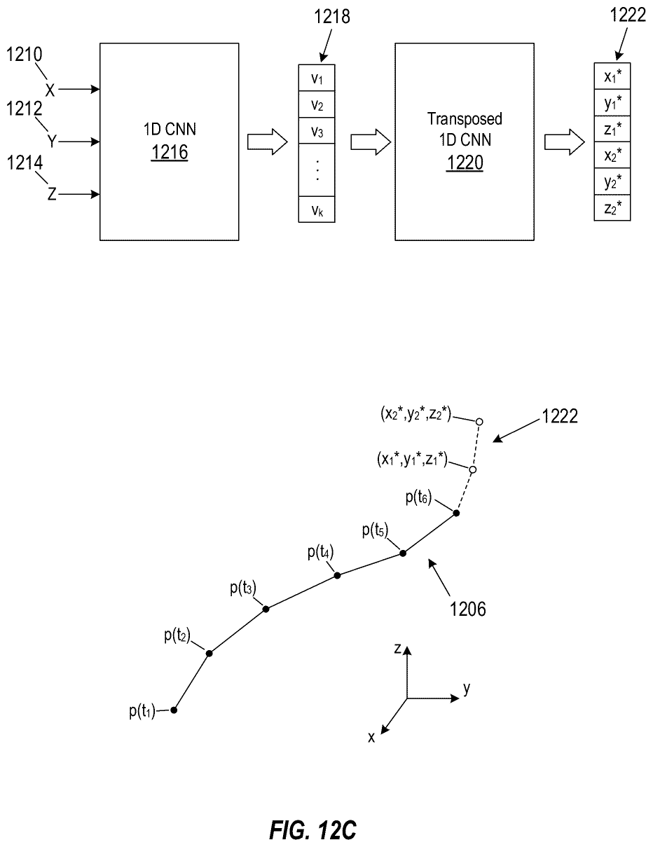

FIG. 12A depicts an example trajectory 1202 of an automobile 1204 traveled over time. The trajectory 1202 is represented by a polyline 1206 formed from the set of points

$${\{ p ( {t}_{i} ) \}}_{i = 1}^{6}$$

recorded at regularly spaced time stamps tᵢ, where i=1, . . . , 6. The resolution of the polyline can be determined by the time interval between time stamps. A higher resolution polyline representation of the trajectory has a shorter time interval between time stamps and larger number of points than a lower resolution polyline representation of the same trajectory.

FIG. 12B depicts an example channel matrix 1208 of the set of points {p (tᵢ)}ᵢ₌₁⁶ that form the polyline 1206. The x-coordinates of the points form an X-channel 1210. The y-coordinates of the points form a Y-channel 1212. The z-coordinates of the points form a Z-channel 1214.

FIG. 12C depicts an example of generating a predicted (e.g., future) trajectory 1218 of the automobile. The predicted trajectory 1218 is generated by inputting the X-channel 1210, the Y-channel 1212, and Z-channel 1214 into 1D CNN 1216 to extract features 1218 from the X-, Y-, and Z-channels. The extracted features 1218 are input to a transposed 1D CNN 1220 to obtain a polyline 1222 representing a predicted future trajectory of the automobile. In this example, the predicted trajectory 1222 is composed of two points added to the end of the polyline 2006.

In certain aspects, trajectory prediction may be performed by a computing device located in the automobile. For example, the automobile obtains the ordered set of points of the polyline from the GPS locator. The automobile may include a computing device that inputs the X-channel 1210, the Y-channel 1212, and Z-channel 1214 into the 1D CNN 1216 and executes the transposed 1D CNN 1220 to obtain the predicted trajectory 1222.

In certain aspects, trajectory prediction may be performed in the cloud. For example, the ordered set of points of the polyline may be sent from the GPS locator to the cloud using 5G or 6G network. A computing device in cloud inputs the X-channel 1210, the Y-channel 1212, and Z-channel 1214 into the 1D CNN 1216 and executes the transposed 1D CNN 1220 to obtain the predicted trajectory 1222. The predicted trajectory 1222 may be sent to the automobile.

In certain aspects, trajectory prediction may be partially performed in the cloud and by a computing device in the automobile. For example, the automobile obtains the ordered set of points of the polyline from the GPS locator. The automobile may include a computing device that inputs the X-channel 1210, the Y-channel 1212, and Z-channel 1214 into the 1D CNN 1216 to obtain the feature vector 1218 and sends the extracted feature vector 1218 to the cloud using a 5G or a 6G network. A computing device in the cloud inputs the extracted feature vector 1218 to the transposed 1D CNN 1220 to obtain the predicted trajectory 1222. The predicted trajectory 1222 may be sent to the automobile.

In certain aspects, the automobile obtains the ordered set of points of the polyline from the GPS locator and sends the ordered set of point to the cloud using a 5G or a 6G network. A computing device in the cloud inputs the X-channel 1210, the Y-channel 1212, and Z-channel 1214 into the 1D CNN 1216 to obtain the extracted feature vector 1218 and sends the extracted feature vector 1218 to the automobile using a 5G or a 6G network. A computing device in the automobile inputs the feature vector 1218 to the transposed 1D CNN 1220 to obtain the predicted trajectory 1222.

In certain aspects, the 1D CNN can be used in optical character recognition of handwritten numbers and characters. Coordinate locations of spaced apart pixels of images of handwritten digits and characters may form an ordered set of points of a polyline representation of the handwritten number or character.

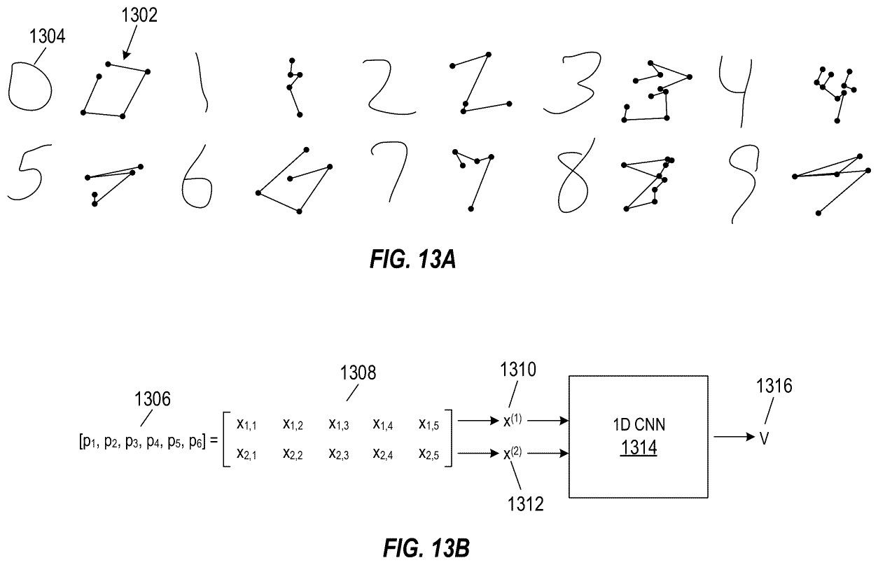

FIG. 13A depicts examples of handwritten numbers. Adjacent to each number is a polyline representation of the number. The set of points of each polyline are represented by solid dots connected by lines. For example, a set of five points connected by lines form a polyline 1302 representation of the number “0” 1304.

The points of a polyline form a 2 by N channel matrix of the polyline. The two channels are input to a 1D CNN that has been trained to generate a feature vector representation of the number and character represented by the polyline.

FIG. 13B depicts an example of five points 1306 that correspond to the five points of the polyline 1302 representation of the handwritten number “0” 1304. The set of points 1306 form a channel matrix 1308. The corresponding channels 1310 and 1312 are input to 1D CNN 1314 that generates a feature vector 1316 that can be used to identify the handwritten number represented by the polyline.

### Example Operations for Representing Polylines and Polygons

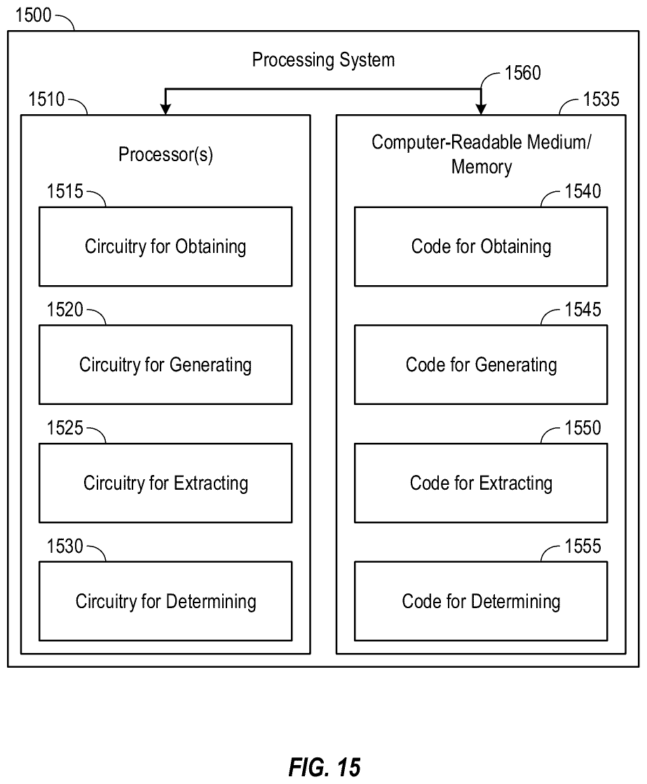

In one aspect, method 1400, or any aspect related to it, may be performed by an apparatus, such as processing system 1500 of FIG. 15, which includes various components operable, configured, or adapted to perform the method 1400.

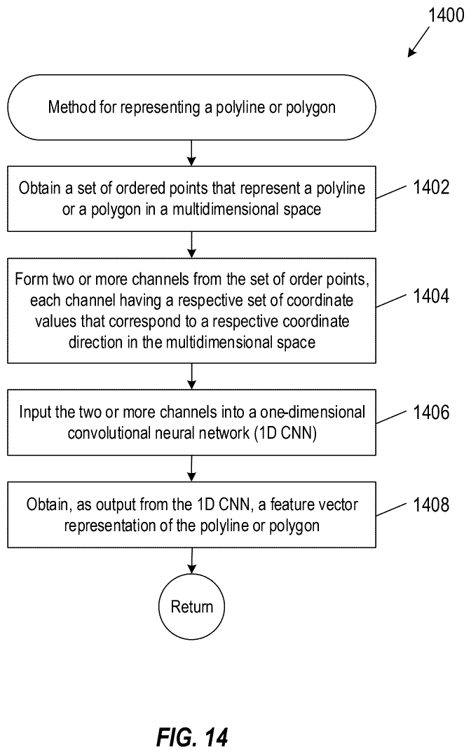

Note that FIG. 14 is just one example of a method, and other methods including fewer, additional, or alternative steps are possible consistent with this disclosure.

Method 1400 begins at block 1402 with obtaining an ordered set of points that represent a polyline or a polygon in a multidimensional space as described above with reference to FIGS. 1A-1B.

Method 1400 then proceeds to block 1404 with forming two or more channels from the ordered set of points as described above with reference to FIGS. 3-4, each channel having a respective set of coordinate values that corresponds to a respective coordinate direction in the multidimensional space.

Method 1400 then proceeds to block 1406 with inputting the two or more channels into a one-dimensional convolutional neural network (1D CNN) as described above with reference to FIGS. 5-6B.

Method 1400 then proceeds to block 1408 with obtaining, as output from the 1D CNN, a feature vector representation of the polyline or polygon as described above with reference to FIGS. 5-6B.

The method 1400 provides a more efficient way of using the geometrical, local, and/or global properties of polylines and/or polygons than MLPs and 2D and 3D CNNs. For example, the method 1400 employs a 1D CNN that may significantly reduce the number of training samples, the complexity and number of learnable parameters, and/or the risk of overfitting. In some cases, the two or more channels from the ordered set of points formed from the polyline or polygon that are input to the 1D CNN have a lower complexity and may be able to extract more useful and compact features from polylines and polygons than MLPs and 2D and 3D CNNs. In certain aspects, by using spatial information embedded in the channels, the 1D CNN may decrease the number of trainable parameters of the 1D CNN and hence reduce the amount of training data needed for training the 1D CNN. The sample efficiency may also translate to reduced cost of annotation of training data as a smaller number of samples of the training data may be annotated. The 1D CNN may also use far fewer computational resources and less memory than an MLP and 2D and 3D CNNs. This in turn may imply lower computational budget than an MLP and 2D and 3D CNNs.

In one aspect, the 1D CNN comprises one of a dilated 1D CNN or a deformable 1D CNN.

In one aspect, block 1406 includes convolving each of the two or more channels with a kernel to reduce lengths of the two or more channels.

In one aspect, block 1406 includes normalizing the two or more channels.

In one aspect, the method 1400 includes decoding the feature vector and recovering the ordered set of points.

In one aspect, the block 1402 includes obtaining a current trajectory of an automobile; and dividing the current trajectory into line segments, wherein end points of the line segments are the ordered set of points.

In one aspect, the block 1402 includes predicting a future trajectory of the automobile based on the feature vector.

In one aspect, the block 1402 includes obtaining a map; and obtaining the ordered set of points based on the map.

In one aspect, the block 1402 includes vectorising an object of the map.

In one aspect, the method 1400 includes identifying a type of object based on the feature vector.

In one aspect, the type of the object is a building, a road, a body of water, a river, a road boundary, or a pedestrian crossing.

In one aspect, the method 1400 further includes: obtaining a map model comprising a plurality of sets of ordered points, including the ordered set of points, wherein each ordered set of points represents a respective object of the map model as a respective polyline or a respective polygon; wherein to obtain the feature vector comprises to obtain, as output from the 1D CNN, a set of feature vectors, including the feature vector, wherein each feature vector of the set of feature vectors corresponds to a respective ordered set of points of the plurality of sets of ordered points; determining clusters of feature vectors in the set of feature vectors, wherein each cluster of feature vectors is associated with a respective type of object; and classifying, based on the feature vector, the polyline or the polygon as a type of object based on which of the clusters has a largest number of feature vectors, among the clusters, that are closest to the feature vector.

In one aspect, the type of object is a road boundary, a roundabout, or a pedestrian crossing.

In one aspect, the 1D CNN comprises a plurality of 1D convolutional layers.

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 15 is just one example of a method, and other methods including fewer, additional, or alternative operations are possible consistent with this disclosure.

### Example Processing System for Representing Polylines and Polygons

FIG. 15 depicts an example processing system 1500 configured to perform various aspects described herein, including, for example, method 1400 as described above with respect to FIG. 14.

Processing system 1500 includes one or more processors 1510. In various aspects, the one or more processors 1510 may be representative of one or more of a receive processor, a transmit processor, and/or a controller/processor. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1610, enable and cause the one or more processors 1510 to perform the method 1400 described with respect to FIG. 14, or any aspect related to it, including any operations described in relation to FIG. 14. Note that reference to a processor performing a function of processing system 1500 may include one or more processors performing that function of processing system 1500, such as in a distributed fashion.

In the depicted example, computer-readable medium/memory 1535 stores code for obtaining 1540, code for generating 1545, code for extracting 1550, and code for determining 1555. Processing of the code 1540-1555 may enable and cause the processing system 1500 to perform the method 1400 described with respect to FIG. 14, or any aspect related to it.

The one or more processors 1510 include circuitry configured to implement (e.g., execute) the code stored in the computer-readable medium/memory 1535, including circuitry for obtaining 1515, circuitry for generating 1520, circuitry for extracting 1525, and circuitry for determining 1530. Processing with circuitry 1515-1530 may enable and cause the processing system 1500 to perform the method 1400 described with respect to FIG. 14, or any aspect related to it.

More generally, means for obtaining, generating, extracting, or determining may include one or more processors 1510 of the processing system 1500 in FIG. 15.

### Example Clauses

Implementation examples are described in the following numbered clauses:

Clause 1: A method for representing polylines and polygons, comprising: obtaining a ordered set of points that represent a polyline or a polygon in a multidimensional space; forming two or more channels from the ordered set of points, each channel having a respective set of coordinate values that corresponds to a respective coordinate direction in the multidimensional space; inputting the two or more channels into a one-dimensional convolutional neural network (1D CNN); and obtaining, as output from the 1D CNN, a feature vector representation of the polyline or polygon.

Clause 2: The method of Clause 1, wherein the 1D CNN comprises one of a dilated 1D CNN or a deformable 1D CNN.

Clause 3: The method of any one of Clauses 1-2, wherein the 1D CNN is configured to convolve each of the two or more channels with a one-dimensional kernel to reduce lengths of the two or more channels.

Clause 4: The method of any one of Clauses 1-3, wherein the 1D CNN is configured to normalize the two or more channels.

Clause 5: The method of any one of Clauses 1-4, further comprising decoding the feature vector and recovering the ordered set of points.

Clause 6: The method of any one of Clauses 1-5, wherein obtaining the ordered set of points comprises: obtaining a current trajectory of an automobile; and dividing the current trajectory into line segments, wherein end points of the line segments are the ordered set of points, and wherein the feature vector corresponds to a predicted trajectory of the automobile.

Clause 7: The method of any one of Clauses 1-6, wherein obtaining the ordered set of points comprises: obtaining a map; and vectorizing an object of the map to obtain the ordered set of points, wherein the feature vector identifies a type of object.

Clause 8: The method of Clause 7, wherein the type of object is a building, a road, a body of water, or a river.

Clause 9: The method of any one of Clauses 1-8, wherein obtaining the ordered set of points comprises: obtaining a map model with the ordered set of points, wherein the ordered set of points represent an object of the map model as the polyline or the polygon, and wherein the feature vector identifies a type of object.

Clause 10: The method of claim 9, wherein the type of object is a road boundary or a pedestrian crossing.

Clause 11: One or more apparatuses, comprising: one or more memories comprising executable instructions; and one or more processors configured to execute the executable instructions and cause the one or more apparatuses to perform a method in accordance with any one of clauses 1-10.

Clause 12: One or more apparatuses, comprising: one or more memories; and one or more processors, coupled to the one or more memories, configured to cause the one or more apparatuses to perform a method in accordance with any one of Clauses 1-10.

Clause 13: One or more apparatuses, comprising: one or more memories; and one or more processors, coupled to the one or more memories, configured to perform a method in accordance with any one of Clauses 1-10.

Clause 14: One or more apparatuses, comprising means for performing a method in accordance with any one of Clauses 1-10.

Clause 15: One or more non-transitory computer-readable media comprising executable instructions that, when executed by one or more processors of one or more apparatuses, cause the one or more apparatuses to perform a method in accordance with any one of Clauses 1-10.

Clause 16: One or more computer program products embodied on one or more computer-readable storage media comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for representing polylines and polygons, comprising:
one or more memories; and
one or more processors coupled to the one or more memories, the one or more processors configured to cause the apparatus to:
obtain an ordered set of points that represent a polyline or a polygon in a multidimensional space;
form two or more channels from the ordered set of points, each channel having a respective set of coordinate values that corresponds to a respective coordinate direction in the multidimensional space;
input the two or more channels into a one-dimensional convolutional neural network (1D CNN); and
obtain, as output from the 1D CNN, a feature vector representation of the polyline or polygon.

2. The apparatus of claim 1, wherein the one or more processors are configured to cause the apparatus to decode the feature vector and recover the ordered set of points.

3. The apparatus of claim 1, wherein the 1D CNN comprises one of a dilated 1D CNN or a deformable 1D CNN.

4. The apparatus of claim 1, wherein the 1D CNN is configured to convolve each of the two or more channels with one or more kernels to reduce lengths of the two or more channels.

5. The apparatus of claim 1, wherein the 1D CNN is configured to normalize the two or more channels.

6. The apparatus of claim 1, wherein to obtain the ordered set of points, the one or more processors are configured to cause the apparatus to:
obtain a current trajectory of an automobile; and
divide the current trajectory into line segments, wherein end points of the line segments are the ordered set of points.

7. The apparatus of claim 6, wherein the one or more processors are configured to cause the apparatus to predict a future trajectory of the automobile based on the feature vector.

8. The apparatus of claim 1, wherein to obtain the ordered set of points, the one or more processors are configured to cause the apparatus to:
obtain a map; and
obtain the ordered set of points based on the map.

9. The apparatus of claim 8, wherein to obtain the ordered set of points based on the map comprises to vectorize an object of the map.

10. The apparatus of claim 8, wherein the one or more processors are configured to cause the apparatus to identify a type of an object based on the feature vector.

11. The apparatus of claim 10, wherein the type of the object is a building, a road, a body of water, a river, a road boundary, or a pedestrian crossing.

12. The apparatus of claim 1, wherein the one or more processors are configured to cause the apparatus to:
obtain a map model comprising a plurality of sets of ordered points, including the ordered set of points, wherein each ordered set of points represents a respective object of the map model as a respective polyline or a respective polygon;
wherein to obtain the feature vector comprises to obtain, as output from the 1D CNN, a set of feature vectors, including the feature vector, wherein each feature vector of the set of feature vectors corresponds to a respective ordered set of points of the plurality of sets of ordered points;
determine clusters of feature vectors in the set of feature vectors, wherein each cluster of feature vectors is associated with a respective type of object; and
classify, based on the feature vector, the polyline or the polygon as a type of object based on which of the clusters has a largest number of feature vectors, among the clusters, that are closest to the feature vector.

13. The apparatus of claim 12, wherein the type of object is a road boundary, a roundabout, or a pedestrian crossing.

14. The apparatus of claim 1, wherein the 1D CNN comprises a plurality of 1D convolutional layers.

15. A method for representing polylines and polygons, the method comprising:
obtaining an ordered set of points that represent a polyline or a polygon in a multidimensional space;
forming two or more channels from the ordered set of points, each channel having a respective set of coordinate values that corresponds to a respective coordinate direction in the multidimensional space;
inputting the two or more channels into a one-dimensional convolutional neural network (1D CNN); and
obtaining, as output from the 1D CNN, a feature vector representation of the polyline or polygon.

16. The method of claim 15, wherein the 1D CNN comprises one of a dilated 1D CNN or a deformable 1D CNN.

17. The method of claim 15, wherein inputting the two or more channels into the 1D CNN) comprises convolving each of the two or more channels with one or more kernels to reduce lengths of the two or more channels.

18. The method of claim 15, wherein obtaining the ordered set of points comprises:
obtaining a current trajectory of an automobile; and
dividing the current trajectory into line segments, wherein end points of the line segments are the ordered set of points.

19. The method of claim 18, further comprises predicting a future trajectory of the automobile based on the feature vector.

20. A non-transitory computer-readable medium comprising instructions, which when executed by one or more processors of an apparatus, cause the apparatus to perform one or more operations comprising to:
obtain an ordered set of points that represent a polyline or a polygon in a multidimensional space;
form two or more channels from the ordered set of points, each channel having a respective set of coordinate values that corresponds to a respective coordinate direction in the multidimensional space;
input the two or more channels into a one-dimensional convolutional neural network (1D CNN); and
obtain, as output from the 1D CNN, a feature vector representation of the polyline or polygon.
